(19) United States
(12) Patent Application Publication
(10) Pub. No.: US 2023/0059082 A1
(43) Pub. Date: Feb. 23, 2023

(54) ONE-PIECE SOLUTION OF EXTERIOR CAMERA CLEANING NOZZLE INTEGRATED INTO CAMERA MOUNTING BRACKET FOR AUTOMOTIVE APPLICATION

(71) Applicant: Panasonic Automotive Systems Company of America, Division of Panasonic Corporation of North America, PEACHTREE CITY, GA (US)

(72) Inventor: ARON BERNARD SHROLL, DUBLIN, OH (US)

(21) Appl. No.: 17/693,023

(22) Filed: Mar. 11, 2022

Related U.S. Application Data
(60) Provisional application No. 63/234,738, filed on Aug. 19, 2021.

(51) Int. Cl. B60S 1/52; B60S 1/56; B60S 1/54; B60R 11/04

(52) U.S. Cl. CPC B60S 1/52; B60S 1/56; B60S 1/54; B60R 11/04

(57) ABSTRACT

A motor vehicle includes an imaging device capturing images of a scene surrounding the motor vehicle, and a one-piece bracket attached to a body of the vehicle. The imaging device is attached to the one-piece bracket. The one-piece bracket includes a nozzle configured and positioned to carry a fluid such that the fluid is ejected from the nozzle and washes the imaging device.

### CROSS-REFERENCED TO RELATED APPLICATIONS

This application claims benefit of U.S. Provisional Application No. 63/234,738, filed on Aug. 19, 2021, the disclosure of which is hereby incorporated by reference in its entirety for all purposes.

### BACKGROUND OF THE INVENTION

### 1. Field of the Invention

The present invention relates to a camera washer system in a motor vehicle.

### 2. Description of the Related Art

Camera washer systems are fairly new to the United States market. The first camera washer system for Honda launched in model year 2018 (Acura RDX) for the rear backup camera. Since then and now, washer systems are integral to good camera function and provide a convenience. Washer fluid is pumped to the nozzle location via tubing in a way similar to the way washer fluid is provided for cleaning the windshield for improved visibility. The camera washer nozzles used since 2018 are specialized, with a focused spray of water or air and pressure designed to wash the camera only. The alternative to a camera washer is cleaning the lens by hand, but Honda has added this washer feature to cameras as a convenience item. With more cameras being used on the vehicle, the number of washers needed also increases.

In the current process, the camera and the bracket are assembled together as a camera assembly, and the nozzle/washer assembly is hand-assembled to the camera assembly via a clip. The fluid hose connects onto the elbow piece on the nozzle. Then, the camera assembly snaps into place onto the rear garnish via install clips, and the washer hose connection remains hidden behind the garnish.

### SUMMARY OF THE INVENTION

The present invention provides a vehicular camera washer system in which the washer nozzle is built into the camera bracket. That is, the camera bracket itself is the nozzle.

The invention comprises, in one form thereof, a motor vehicle including an imaging device capturing images of a scene surrounding the motor vehicle, and a one-piece bracket attached to a body of the vehicle. The imaging device is attached to the one-piece bracket. The one-piece bracket includes a nozzle configured and positioned to carry a fluid such that the fluid is ejected from the nozzle and washes the imaging device.

The invention comprises, in another form thereof, a method of washing an imaging device on a motor vehicle, including attaching the imaging device to a one-piece bracket. The one-piece bracket includes a nozzle, and is attached to a body of the motor vehicle. The nozzle of the one-piece bracket is used to carry a fluid. The fluid is ejected from the nozzle such that the ejected fluid washes the imaging device. The imaging device is used to capture images of a scene surrounding the motor vehicle.

The invention comprises, in yet another form thereof, a camera washer assembly for a motor vehicle including an imaging device capturing images of a scene surrounding the motor vehicle. A one-piece bracket is attached to the imaging device. The one-piece bracket is attached to a body of the motor vehicle. The one-piece bracket includes a nozzle carrying a fluid such that the fluid is ejected from the nozzle and washes the imaging device.

Advantages of the invention include simplifying the camera washer system and thereby reducing its material cost and assembly cost.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is an overhead view of a motor vehicle including one or more camera washer assemblies of the present invention.

FIG. 2 is an overhead view of one embodiment of a camera washer assembly of the present invention.

FIG. 3 is a front view of the camera washer assembly of FIG. 2.

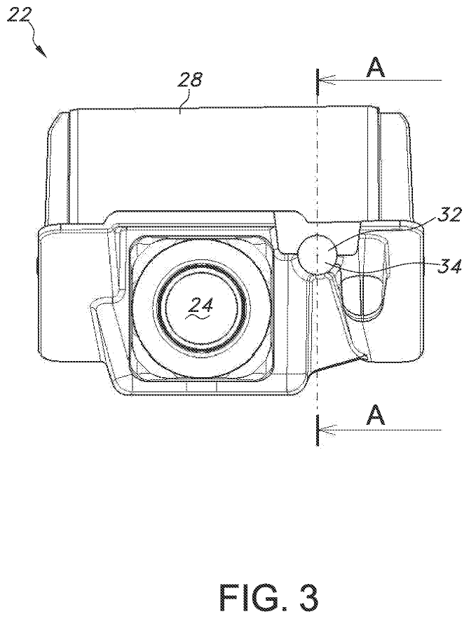

FIG. 4 is a side sectional view along line A-A of FIG. 3.

FIG. 5 is a front left overhead perspective view of the camera washer assembly of FIG. 2.

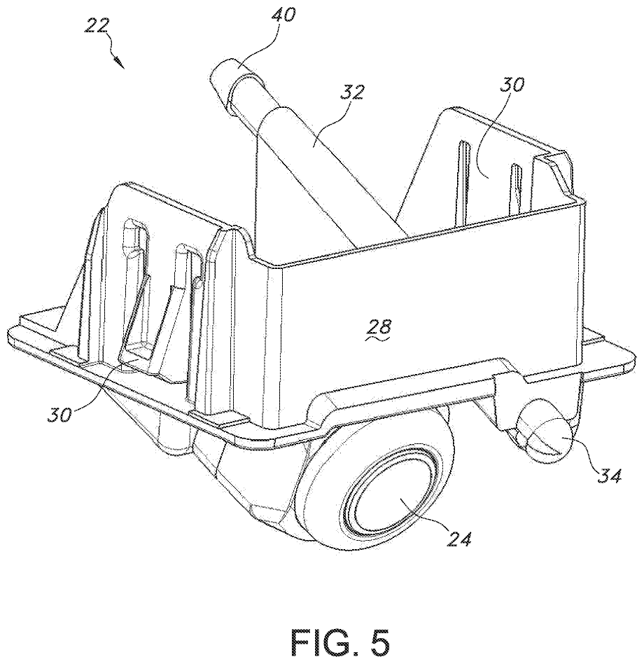

FIG. 6 is a front right overhead perspective view of the camera washer assembly of FIG. 2.

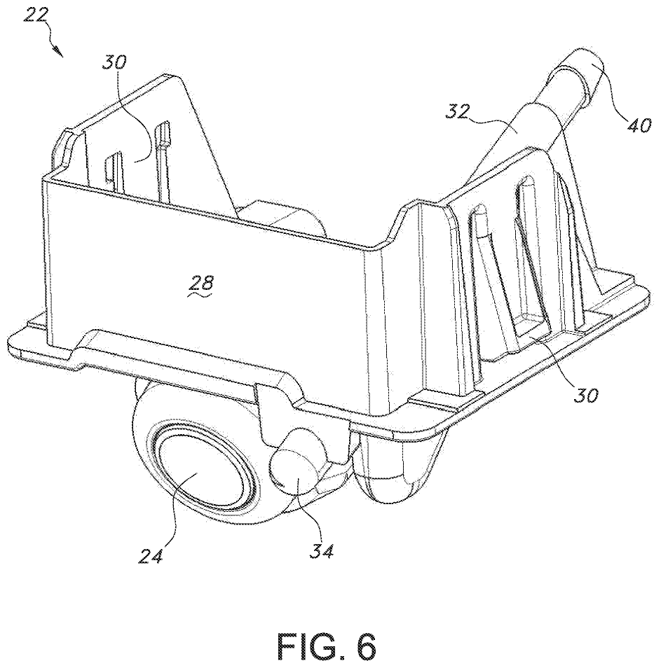

FIG. 7 is a front right underside perspective view of the bracket/washer nozzle of the camera washer assembly of FIG. 2.

FIG. 8 is a flow chart of one embodiment of a method of the present invention for washing an imaging device on a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

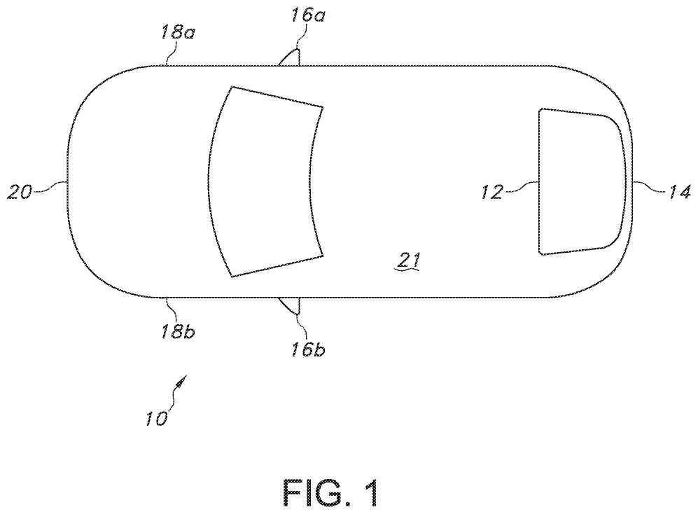

FIG. 1 illustrates a motor vehicle 10 including one or more camera washer assemblies of the present invention. A monitoring camera may be at location 12; a parking camera may be mounted on the rear of vehicle 10 at location 14; a blind spot camera, surround view camera and/or monitoring camera may be at locations 16a-b; an intersection camera may be at locations 18a-b; and a frontal camera, laser scanner, and/or night vision scanner may be at location 20. Any of these cameras and scanners may incorporated into a camera washer assembly or scanner washer assembly of the present invention that is attached to a body 21 of vehicle 10. Although only a camera washer assembly is described herein, it is to be understood that a scanner washer assembly of the present invention is substantially identical structurally to the described camera washer assembly. Cameras and scanners may be conjunctively referred to herein as imaging devices. It is possible for other types of imaging devices to be incorporated into a washer assembly that is substantially similar to the camera washer assembly described herein.

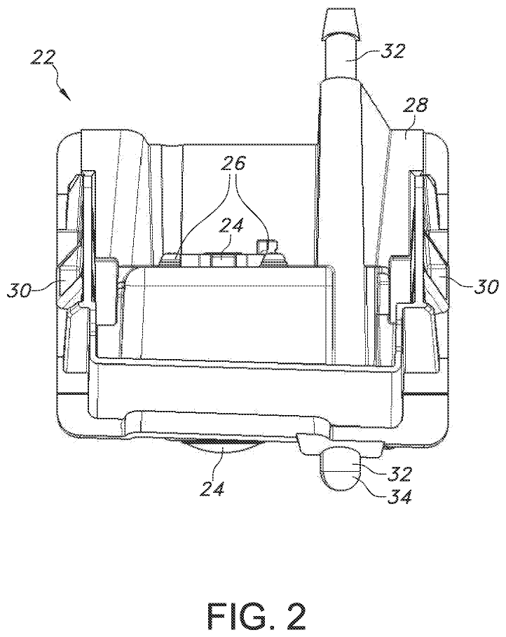

FIG. 2 illustrates one embodiment of a camera washer assembly 22 of the present invention, including a camera 24 and a bracket/washer nozzle combination 28, hereinafter referred to as bracket/nozzle 28. Camera attachment screws 26 secure camera 24 to bracket/nozzle 28. Bracket/nozzle 28 includes bracket attachment clips 30 for attaching bracket/nozzle 28 to a body of vehicle 10. Bracket/nozzle 28 also includes a built-in or molded-in nozzle 32 having a head 34 through which a fluid such as air or water may be ejected.

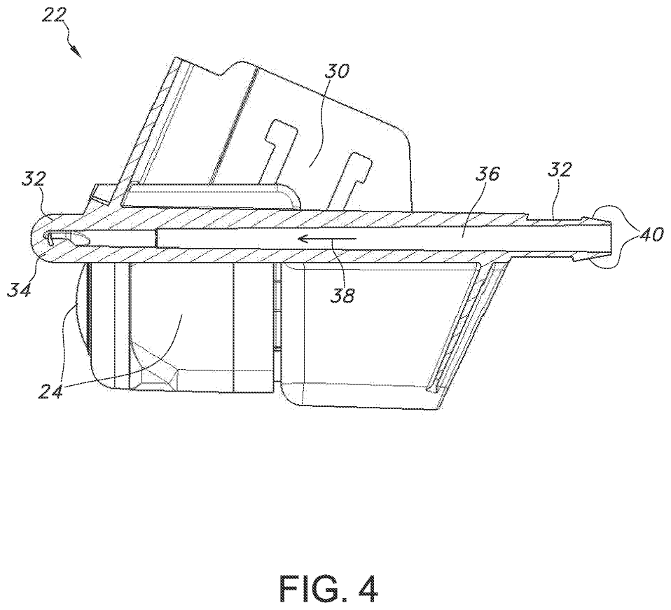

FIG. 4 illustrates the interior of nozzle 32, including a channel 36 through which the fluid travels in direction 38. An upstream end of nozzle 32 includes a barb 40 which enables a rubber fluid supply hose (not shown) to be secured to nozzle 32.

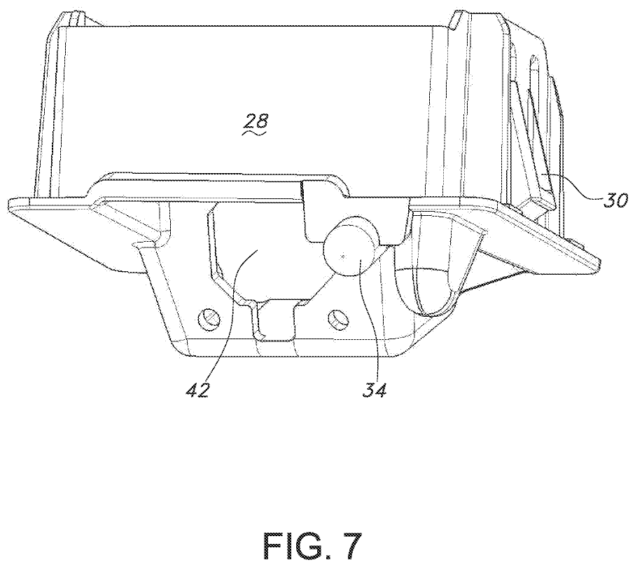

FIG. 7 illustrates bracket/nozzle 28 of camera washer assembly 10. A throughhole 42 has a size and shape to snugly receive camera 24 therein. Bracket/nozzle 28 is integrally formed of one piece, possibly in a plastic injection molding manufacturing process.

During use, a fluid, such as air, washer fluid, or water, is pumped into channel 36 of nozzle 32 such that it flows in direction 38 and is ejected out of nozzle head 34. After the fluid is ejected out of head 34, the fluid has a trajectory so as to wash dirt and debris off of camera 24 so that camera 24 can capture images of a higher quality than it could before the washing.

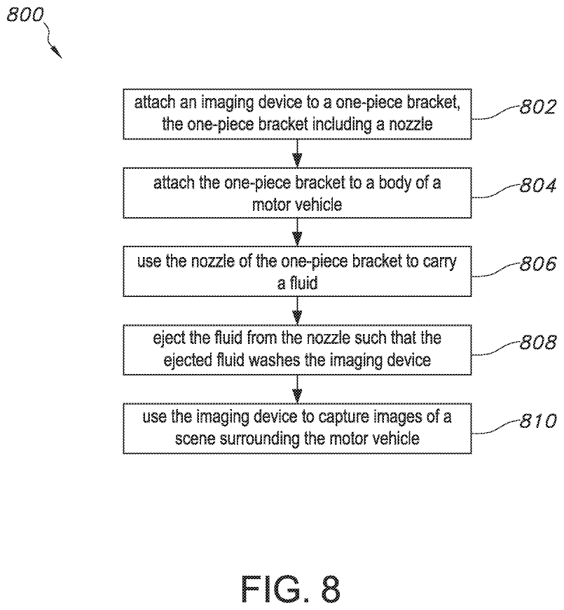

FIG. 8 illustrates one embodiment of a method 800 of the present invention for washing an imaging device on a motor vehicle. In a first step 802, the imaging device is attached to a one-piece bracket. The one-piece bracket includes a nozzle. For example, camera 24 may be attached to a one-piece bracket/nozzle combination 28 by screws 26.

Next, in step 804, the one-piece bracket is attached to a body of the motor vehicle. For example, bracket/nozzle 28 includes bracket attachment clips 30 for attaching bracket/nozzle 28 to a body of vehicle 10.

In a next step 806, the nozzle of the one-piece bracket is used to carry a fluid. For example, nozzle 28 may carry water, air, or washer fluid through a channel 36.

In step 808, the fluid is ejected from the nozzle such that the ejected fluid washes the imaging device. For example, the fluid may be pumped into channel 36 of nozzle 32 such that it flows in direction 38 and is ejected out of nozzle head 34. After the fluid is ejected out of head 34, the fluid has a trajectory so as to wash dirt and debris off of camera 24.

In a final step 810, the imaging device is used to capture images of a scene surrounding the motor vehicle. For example, camera 24 may be disposed at any of locations 12, 14, 16a-b, 18a-b or 20 so as to capture images around motor vehicle 10.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A motor vehicle, comprising:
a vehicle body;
an imaging device configured to capture images of a scene surrounding the motor vehicle; and
a one-piece bracket attached to the vehicle body, the imaging device being attached to the one-piece bracket, the one-piece bracket including a nozzle configured and positioned to carry a fluid such that the fluid is ejected from the nozzle and washes the imaging device.

2. The motor vehicle of claim 1 wherein the one-piece bracket is an integral, plastic injection molded one-piece bracket.

3. The motor vehicle of claim 1 wherein the one-piece bracket is elongate and includes two opposite ends and an elongate channel extending between the two opposite ends, the channel being configured to carry the fluid.

4. The motor vehicle of claim 3 wherein the elongate channel is substantially parallel to an optical axis of the imaging device.

5. The motor vehicle of claim 4 wherein the elongate channel is disposed at a higher vertical level than the optical axis of the imaging device.

6. The motor vehicle of claim 1 wherein the fluid comprises water, air, or washer fluid.

7. The motor vehicle of claim 1 wherein the one-piece bracket includes a throughhole, an optical axis of the imaging device extending through the throughhole.

8. A method of washing an imaging device on a motor vehicle, the method comprising:
attaching the imaging device to a one-piece bracket, the one-piece bracket including a nozzle;
attaching the one-piece bracket to a body of the motor vehicle;
using the nozzle of the one-piece bracket to carry a fluid;
ejecting the fluid from the nozzle such that the ejected fluid washes the imaging device; and
using the imaging device to capture images of a scene surrounding the motor vehicle.

9. The method of claim 8 further comprising forming the one-piece bracket by a plastic injection molding process.

10. The method of claim 8 wherein the one-piece bracket is elongate and includes two opposite ends and an elongate channel extending between the two opposite ends, the channel carrying the fluid.

11. The method of claim 10 wherein the elongate channel is substantially parallel to an optical axis of the imaging device when the one-piece bracket is attached to the imaging device.

12. The method of claim 11 wherein the elongate channel is disposed at a higher vertical level than the optical axis of the imaging device when the one-piece bracket is attached to both the body of the motor vehicle and the imaging device.

13. The method of claim 8 wherein the fluid comprises water, air, or washer fluid.

14. The method of claim 8 wherein the one-piece bracket includes a throughhole, an optical axis of the imaging device extending through the throughhole when the one-piece bracket is attached to the imaging device.

15. A camera washer assembly for a motor vehicle, the camera washer assembly comprising:
an imaging device configured to capture images of a scene surrounding the motor vehicle; and
a one-piece bracket attached to the imaging device, the one-piece bracket being configured to be attached to a body of the motor vehicle, the one-piece bracket including a nozzle configured and positioned to carry a fluid such that the fluid is ejected from the nozzle and washes the imaging device.

16. The camera washer assembly of claim 15 wherein the one-piece bracket is an integral, plastic injection molded one-piece bracket.

17. The camera washer assembly of claim 15 wherein the one-piece bracket is elongate and includes two opposite ends and an elongate channel extending between the two opposite ends, the channel being configured to carry the fluid.

18. The camera washer assembly of claim 17 wherein the elongate channel is substantially parallel to an optical axis of the imaging device.

19. The camera washer assembly of claim 15 wherein the fluid comprises water, air, or washer fluid.

20. The camera washer assembly of claim 15 wherein the one-piece bracket includes a throughhole, an optical axis of the imaging device extending through the throughhole.
